(19) United States
(12) Patent Application Publication
(10) Pub. No.: US 2021/0215476 A1
(43) Pub. Date: Jul. 15, 2021

(54) SYSTEM FOR DETERMINING THREE-DIMENSIONAL IMAGES

(71) Applicant: VIT, Saint-Egreve (FR)

(72) Inventors: Loïc BOISSON, Saint-Egreve (FR); Romain ROUX, Saint-Egreve (FR)

(21) Appl. No.: 17/250,097

(22) PCT Filed: Apr. 9, 2019
(86) PCT No.: PCT/FR2019/050837

§ 371 Date: Nov. 24, 2020

(30) Foreign Application Priority Data
May 25, 2018 (FR) 1800513

(51) Int. Cl. G01B 11/25; G06T 7/00; G06T 7/593

(52) U.S. Cl. CPC G01B 11/2545; G06T 7/0004; G06T 2207/30141; G06T 7/593; G01B 11/2513

(57) ABSTRACT

The invention concerns a method of determination of a three-dimensional image of an object (Board), including the projection of a plurality of first images onto the object, each first projected image including first light patterns spaced apart by a first period; the acquisition, for each first projected image, of a first two-dimensional image of the object; the projection of a plurality of second images onto the object, each second projected image including second light patterns spaced apart by a second period different from the first period; the acquisition, for each second projected image, of a second two-dimensional image of the object; and the detection of a translucent area of the object by comparison of first signals obtained from the first images and of second signals obtained from the second images, and, for the translucent area, the determination of each point of the translucent area based on the first and second signals.

### FIELD

The present invention generally concerns optical inspection installations particularly comprising three-dimensional (3D) image determination systems intended for the on-line analysis of objects, particularly of electronic circuits. The invention more particularly concerns optical inspection installations comprising digital cameras.

### BACKGROUND

An optical inspection installation is generally used to verify the sound condition of an object, for example, an electronic circuit, before it is released to the market. The optical inspection installation may provide a 3D image of the object which is analyzed by a computer and/or by an operator to search for possible defects. A 3D image of an object corresponds to a cloud of points, for example, several million points, of at least a portion of the external surface of the object, where each point of the surface is located by its coordinates determined with respect to a three-dimensional space reference system.

The optical inspection installation generally comprises a processing unit capable of performing an automatic analysis of the images of the object to search for possible defects. This is for example done by comparing the image of the object with a reference image. In the case of an electronic circuit comprising, for example, a printed circuit having electronic components affixed thereto, the images of the electronic circuit may be used, in particular, to inspect the sound condition of the solders of the electronic components on the printed circuit.

A method of determining a 3D image comprises the projection of light patterns onto the object to be inspected, for example, fringes, the acquisition of images by cameras while the light patterns are projected onto the object to be inspected, and the determination of the 3D image based on the acquired images. In particular, in the case where the object is laid on a horizontal reference plane, each point of the 3D image may comprise a height coordinate relative to the reference plane.

The object to be inspected may comprise portions made of a translucent material. This may in particular be the case when the object comprises a printed circuit having its board having electronic components welded thereto made of a translucent material.

A disadvantage of a method of determining a 3D image by projection of light patterns onto such an object is that the projected patterns may partially penetrate into the translucent portions of the object. The 3D image of the translucent portions may then be incorrectly determined. In particular, in the case where, for each point of the object, a height coordinate relative to a reference plane is determined, the height coordinate of a point of a translucent portion may be smaller than the value that should have been determined.

### SUMMARY

An object of an embodiment is to at least partly overcome the disadvantages of the previously-described 3D image determination methods and 3D image determination systems.

Another object of an embodiment is to detect the presence of the translucent portions of an object.

Another object of an embodiment is for the 3D image of an object comprising translucent portions to be correctly determined.

Another object of an embodiment is to cause few modifications with respect to a known 3D image determination method.

Thus, an embodiment provides a method of determining a three-dimensional image of an object, comprising:

the projection by at least one projector of a plurality of first images onto the object, each first projected image comprising first light patterns spaced apart by a first period;
the acquisition, for each first projected image, of at least one first two-dimensional image of the object by at least one image sensor;
the projection by said at least one projector of a plurality of second images onto the object, each second projected image comprising second light patterns spaced apart by a second period different from the first period;
the acquisition, for each second projected image, of at least one second two-dimensional image of the object by said at least one image sensor; and
the detection of at least one translucent area of the object by comparison of first signals obtained from the first images and of second signals obtained from the second images and, for the translucent area, the determination of the height of each point of the translucent area based on the first and second signals.

According to an embodiment, the method further comprises:

the projection by said at least one projector of a plurality of third images onto the object, each third projected image comprising third light patterns spaced apart by a third period different from the first period and different from the second period;
the acquisition, for each third projected image, of at least one third two-dimensional image of the object by said at least one image sensor; and
the determination, for the translucent area, of the height of each point of the translucent area based on the first and second signals and on third signals obtained from the third images.

According to an embodiment, the first patterns are periodic along a given direction, with a period equal to the first period in the range from 1 mm to 15 mm.

According to an embodiment, the first light patterns comprise first light fringes.

According to an embodiment, the second patterns are periodic along the given direction, with a period equal to the second period in the range from 1 mm to 15 mm.

According to an embodiment, the second light patterns comprise second light fringes.

According to an embodiment, the first fringes are straight and parallel and the second fringes are straight and parallel.

According to an embodiment, the first patterns are not periodic, the first period corresponding to the average interval between the first patterns.

According to an embodiment, the method comprises determining a first height for each point of the object based on the first images, determining a second height for each point of the object based on the second images, detecting at least one translucent area of the object by comparison of the first and second heights and determining, for each point of the translucent area, a third height for said point based on the first and second heights for said point and on the first and second periods.

According to an embodiment, the first light patterns are phase-shifted from a first projected image to the next one and the second light patterns are phase-shifter from a second projected image to the next one.

An embodiment also provides a system for determining three-dimensional images of an object, comprising:

at least one projector configured to project a plurality of first images onto the object, each first projected image comprising first light patterns spaced apart by a first period, and a plurality of second images onto the object, each second projected image comprising second light patterns spaced apart by a second period different from the first period;
at least one image sensor configured to acquire, for each first projected image, at least one first two-dimensional image of the object and, for each second projected image, at least one second two-dimensional image of the object; and
a unit configured to detect at least one translucent area of the object by comparison of first signals obtained from the first images and of second signals obtained from the second images and, for the translucent area, to determine the height of each point of the translucent area based on the first and second signals.

According to an embodiment, the system comprises a unit for supplying digital images and the projector is capable of projecting said plurality of images onto the object, each of said images being formed by the projector from one of said digital images.

### BRIEF DESCRIPTION OF THE DRAWINGS

The foregoing and other features and advantages will be discussed in detail in the following non-limiting description of specific embodiments in connection with the accompanying drawings, in which:

The foregoing features and advantages, as well as others, will be described in detail in the following description of specific embodiments given by way of illustration and not limitation with reference to the accompanying drawings, in which:

FIGS. 1 and 2 partially and schematically show an embodiment of an electronic circuit optical inspection installation;

FIG. 3 is a partial simplified cross-section view of a 3D image of a printed circuit comprising no translucent portions;

FIG. 4 is a partial simplified cross-section view of the 3D image of the printed circuit of FIG. 2 in the presence of translucent portions;

FIG. 5 shows an example of light patterns capable of being projected during the determination of a 3D image of an object;

FIG. 6 schematically shows the heights of points of a 3D image of a translucent object determined by projecting periodic light patterns with three different periods;

FIG. 7 shows the variation of the bias of the height of the points of a 3D image of a translucent portion of an object according to the period of the periodic light patterns projected onto the object;

FIGS. 8 and 9 show other example of light patterns capable of being projected during the determination of a 3D image of an object; and

FIG. 10 is a block diagram of an embodiment of a method of determining a 3D image.

### DETAILED DESCRIPTION OF THE PRESENT EMBODIMENTS

For clarity, the same elements have been designated with the same reference numerals in the various drawings and, further, the various drawings are not to scale. Unless otherwise specified, expressions “about”, “approximately”, and “substantially” mean to within 10%, preferably to within 5%. Further, only those elements which are useful to the understanding of the present description have been shown and will be described.

In the following description, embodiments will be described in the case of the optical inspection of electronic circuits. However, these embodiments may apply to the determination of three-dimensional images of all types of objects, particularly for the optical inspection of mechanical parts. Call (OX) and (OY) two perpendicular directions. As an example, direction (OX) is horizontal.

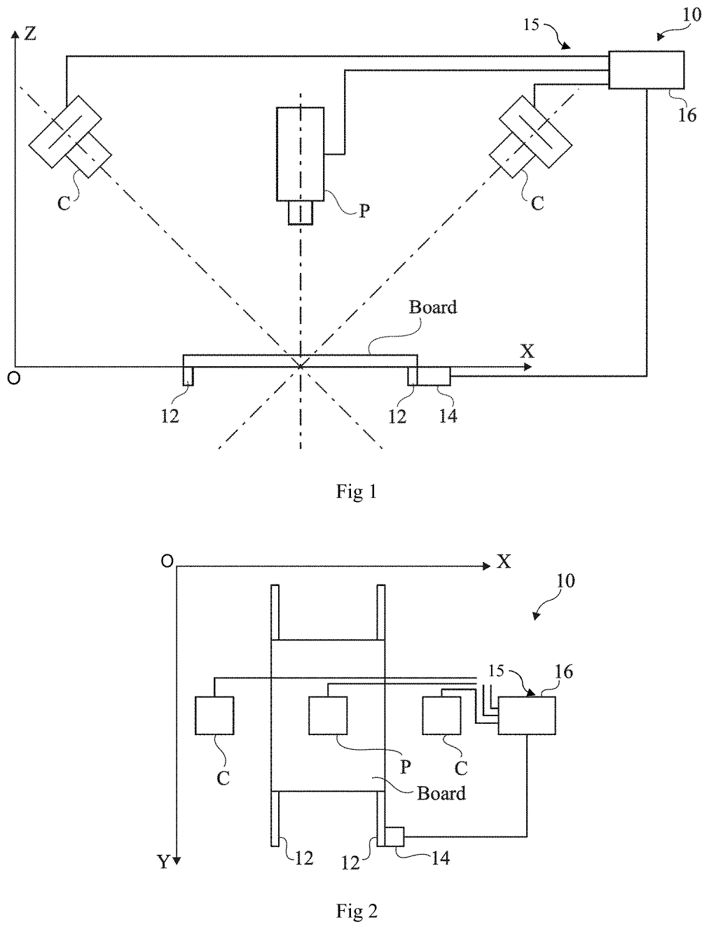

FIGS. 1 and 2 respectively are a front view and a top view, very simplified, of an embodiment of an installation 10 of inspection of an electronic circuit Board. The term electronic circuit indifferently designates an assembly of electronic components interconnected via a support, the support alone used to achieve such an interconnection without the electronic components, or the support without the electronic components, however provided with electronic component bonding means. As an example, the support is a printed circuit and the electronic components are attached to the printed circuit by solder bumps obtained by heating solder paste blocks. In this case, the term electronic circuit indifferently designates the printed circuit alone (with no electronic components or solder paste blocks), the printed circuit provided with the solder paste blocks and without electronic components, the printed circuit provided with the solder paste blocks and with the electronic components before the heating operation, or the printed circuit provided with the electronic components attached to the printed circuit by solder joints.

Electronic circuit Board is placed on a conveyor 12, for example, a planar conveyor. Conveyor 12 is capable of displacing circuit Board parallel to direction (OY). As an example, conveyor 12 may comprise an assembly of straps and of rollers driven by a rotating electric motor 14. As a variation, conveyor 12 may comprise a linear motor displacing a carriage supporting electronic circuit Board. Circuit Board for example corresponds to a rectangular card having a length and a width varying from 50 mm to 550 mm.

Optical inspection installation 10 comprises a system 15 for determining a 3D image of electronic circuit Board. According to an embodiment, system 15 is capable of determining a 3D image of circuit Board by projection of images, for example, fringes, onto the circuit to be inspected. System 15 may comprise an image projection device P comprising at least one projector, a single projector P being shown in FIGS. 1 and 2. Projector P is coupled to a control, image acquisition and processing computer system 16, also called processing unit 16 hereafter. When a plurality of projectors P are present, projectors P may be substantially aligned along a direction parallel to direction (OY). System 16 may comprise a computer and a microcontroller comprising a processor and a non-volatile memory having instructions stored therein, the execution thereof by the processor enabling system 16 to carry out the desired functions. As a variant, system 16 may correspond to a dedicated electronic circuit. Electric motor 14 is further controlled by system 16.

System 15 further comprises an image acquisition device C comprising at least one camera, for example, a digital camera. As an example, two cameras C are shown in FIGS. 1 and 2. Each camera C is coupled to control, image acquisition and processing computer system 16. When a single camera C is present, camera C and projector P may be aligned parallel to direction (OX). When a plurality of cameras C are present, cameras C may be arranged on either side of projector or projectors P, parallel to direction (OX). When a plurality of groups, each comprising at least one projector P and at least one associated camera C, are present, these groups may be substantially aligned parallel to direction (OY). Direction (OX) is parallel to a preferred direction of image acquisition device C and/or of image projection device P. As an example, when a single camera C is present, direction (OX) may be parallel to the straight line running through the optical center of the camera and the optical center of the projector and, when two cameras C are present, direction (OX) may be parallel to the straight line running through the optical centers of the cameras. In the following description, the term two-dimensional image, or 2D image, is used to designate a digital image acquired by one of cameras C and corresponding to a pixel array. In the following description, unless otherwise indicated, the term “image” refers to a 2D image.

The means for controlling conveyor 12, camera C, and projector P of previously-described optical acquisition system 10 are within the abilities of those skilled in the art and are not described in further detail. As a variant, the displacement direction of circuit Board may be a horizontal direction perpendicular to the direction (OY) shown in FIG. 2. In the present embodiment, camera C and projector P are fixed and electronic circuit Board is displaced with respect to camera C and to projector P via conveyor 12. As a variation, electronic circuit Board is fixed and camera C and projector P are displaced with respect to electronic circuit Board by any adapted conveying device.

System 15 is capable of determining a 3D image of circuit Board. A 3D image of circuit Board corresponds to a cloud of points, for example, of several million points, of at least a portion of the external surface of circuit Board, where each point of the surface is located by its coordinates (x, y, z) determined with respect to a three-dimensional space reference system R_{REF} (OX, OY, OZ). In the following description, plane (OX, OY) is called reference plane Pl_{REF}. The z coordinate of a point of the surface of the object then corresponds to the height of the point measured with respect to reference plane Pl_{REF}. As an example, reference plane Pl_{REF} corresponds to the plane containing the upper surface or the lower surface of the printed circuit. Plane Pl_{REF} may be horizontal. Preferably, direction (OZ) is perpendicular to plane (OX, OY), that is, perpendicular to the upper or lower surface of the printed circuit.

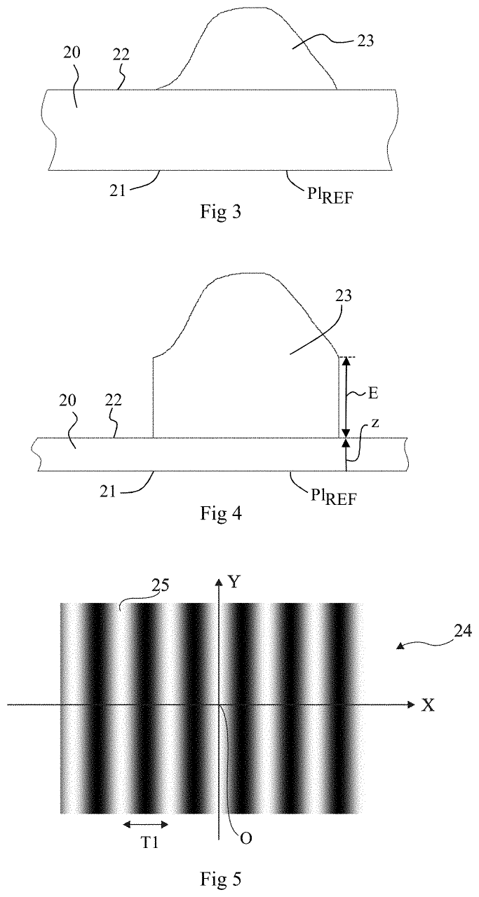

FIG. 3 is an image corresponding to a cross-section view of an example of a circuit to be inspected obtained from a 3D image of the circuit. FIG. 3 shows as an example, the substrate 20 of a printed circuit having planar opposite lower and upper surfaces 21, 22 and a solder paste pad 23 resting on the upper surface 22 of substrate 20. In FIG. 3, substrate 20 and pad 23 are formed of materials opaque to the radiation emitted by projector P so that image 3D correctly copies the external surfaces of substrate 20 and of pad 23.

FIG. 4 is an image corresponding one to cross-section view of the circuit having the same shape as that of the circuit shown in FIG. 3, with the difference that substrate 20 is at least at its surface made of a translucent material. Examples of translucent materials used in electronics and microelectronics are composite materials deriving from epoxy resin, such as FR-4. The radiation emitted by projector P tends to partially penetrate into substrate 20 so that the 3D image which is determined with a conventional 3D image determination method may be incorrect for substrate 20. In FIG. 4, substrate 20 appears to be thinner than it really is, and pad 23 appears to be thicker than it really is. When the coordinate z of a point of the circuit surface corresponds to the height of the point measured with respect to reference plane Pl_{REF}, the determined height z of each point of upper surface 22 of translucent substrate 20 may comprise an error E, also called bias hereafter.

FIG. 5 shows an example of an image 24 capable of being projected by projector P onto circuit Board for the determination of a 3D image. In this example, image 24 comprises a succession of straight, parallel, and periodic light fringes 25. In the present example, when the image 24 shown in FIG. 5 is projected onto reference plane Pl_{REF}, fringes 25 are perpendicular to direction (OX) and appear with a spatial period T1 measured along direction (OX). Fringes 25 may have a light intensity which varies sinusoidally along direction (OX). The method of determining a 3D image may comprise the projection of a plurality of images of the type of image 24 which differ from one another by a phase shift of fringes 25 along direction (OX). Generally, the larger period T1, the greater the reconstruction depth, that is, the size of the height interval over which the 3D image may be determined by the method. According to an embodiment, period T1 is in the range from 1 mm to 15 mm, which enables to obtain a reconstruction depth of the same order of magnitude, according to the configuration of system 15. However, the longer period T1, the greater the reconstruction noise, that is, the lower the accuracy of the determination of the 3D image.

The inventors have shown the existence of a dependency relationship between the error E which occurs during the determination of the points of the 3D image belonging to a translucent portion of the circuit and the period T of the images projected onto the circuit for the determination of the 3D image.

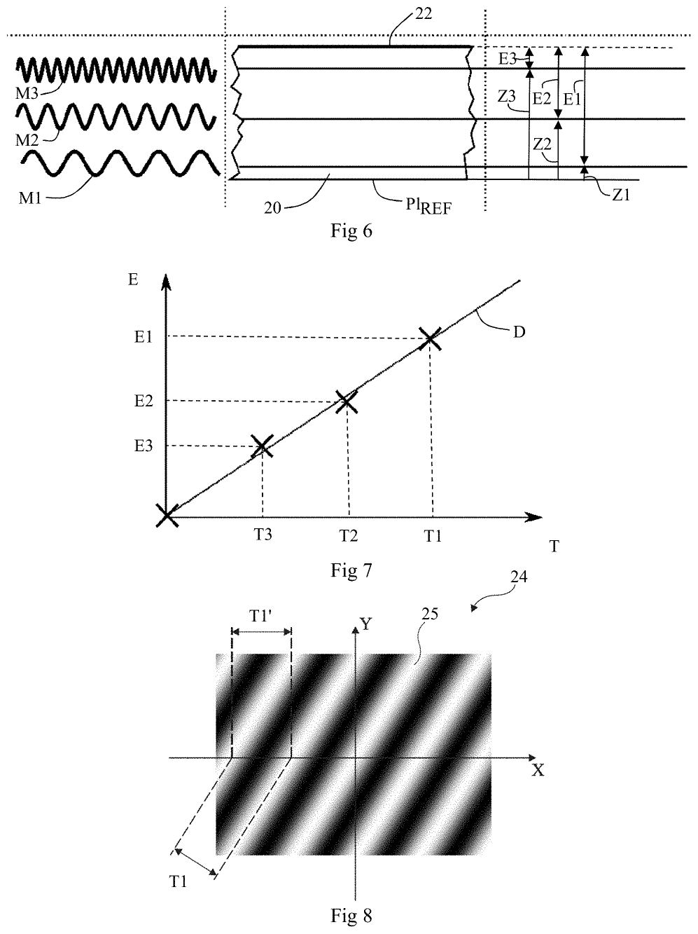

FIGS. 6 and 7 illustrate this dependency relationship.

FIG. 6 schematically shows the heights Z1, Z2, Z3 of points of a 3D image of translucent substrate 20 determined by images with sinusoidal light patterns M1, M2, and M3 for three different periods T1, T2, and T3. Period T3 is shorter than period T2 and period T2 is shorter than period T1. As shown in FIG. 6, the bias E3 obtained with patterns M3 is smaller than the bias E2 obtained with patterns M2 and the E2 is smaller than the bias E1 obtained with patterns M1.

FIG. 7 shows the variation of bias E of the height of the points of a 3D image of translucent substrate 20 according to the period T of the periodic light patterns projected onto substrate 20. The inventors have shown that bias E is substantially proportional to the period T of the light patterns projected onto substrate 20, which corresponds to the line D shown in FIG. 7. In particular, for a pattern period equal to zero, there is no bias. Line D may be determined by linear regression. The height corresponding to the null bias can thus be obtained from line D or directly by extrapolation from values E1, E2, and E3.

The inventors have carried out many tests and have shown that for the translucent materials used in electronics and microelectronics, there is a relation close to proportionality between bias E and period T of the light patterns projected onto the object to be inspected.

Further, the inventors has shown by many tests that a relation close to proportionality between bias E and period T of the light patterns projected onto the object to be inspected is obtained whatever the type of periodic patterns used.

FIG. 8 shows other example of an image 24 comprising light patterns 25 capable of being projected during the determination of a 3D image of an object. In FIG. 8, straight fringes 25 are inclined with respect to direction (OX). Period T1′ corresponds to the projection of period T1 on direction (OX).

According to an embodiment, each image projected for the determination of a 3D image comprises periodic patterns along a preferred direction. In particular, when patterns correspond to periodic fringes, the period of the patterns corresponds to the distance between two successive fringes. In the examples shown in FIGS. 6 and 8, the shown fringes are straight. Generally, light fringes 25 may follow parallel or substantially parallel broken lines, or parallel or substantially parallel lines.

Further, the inventors have shown by many tests that a relation close to proportionality between bias E and period T of the light patterns projected onto the object to be inspected is also obtained, even when the projected light patterns do not have a periodic character but comprise spaced apart light patterns, the average space between adjacent light patterns, possibly along a preferred direction, then corresponding to the previously-described period T.

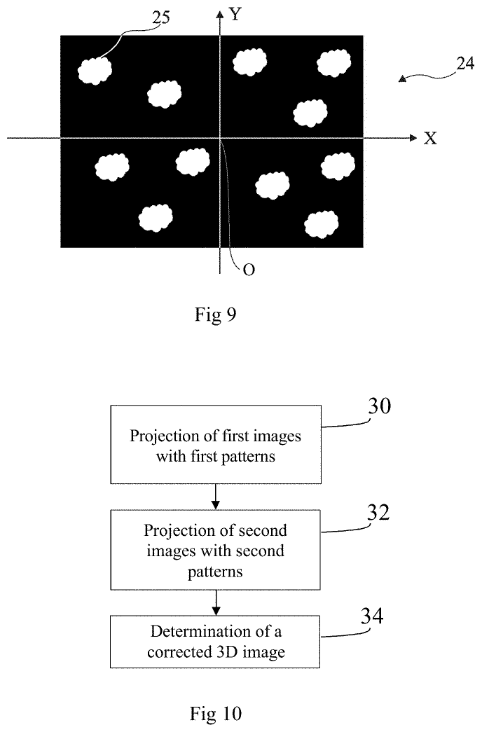

FIG. 9 shows an embodiment of an image 24 where the patterns comprise randomly or pseudo-randomly distributed spots 25. The period of spots 25 corresponding, for example, to the average distance separating the centers of two adjacent spots corresponds to the previously-described period T1. The curve of FIG. 7 has also been obtained on projection of the images of the type of that shown in FIG. 9 by applying a phase shift between two successive projections.

FIG. 10 is a block diagram of an embodiment of a method of determining a 3D image. The method comprises successive steps 30, 32, 34.

At step 30, first images are projected onto the object to be inspected, each first image comprising light patterns having a first period T1. Period T1 may be in the range from 1 mm to 15 mm. In the present embodiment of a method of determining a 3D image, at step 30, a plurality of first images are successively projected onto circuit Board. The first images differ from one another by an offset of the patterns along a preferred direction. As an example, for the image 24 shown in FIG. 5, an offset corresponds to a displacement of fringes 25 along direction (OX). A 2D image is acquired during the projection of each new first image with luminous patterns onto circuit Board.

According to an embodiment, processing unit 16 comprises a unit for determining a digital image and projector P is capable of projecting an image obtained from the digital image. According to an embodiment, projector P is of the type comprising a lamp emitting a beam which is directed towards an optical motor. The optical motor modulates the beam, according to the digital image, to form an image which is projected onto circuit Board. The optical motor may comprise an active area. As an example, the optical motor may comprise an array of liquid crystal shutters or LCD shutter which operates by transmission, the light beam crossing the LCD shutter. As a variant, the optical motor may implement the DLP (digital light processing) technology, which relies on the use of a device comprising an array of adjustable micro-mirrors, the light beam reflecting on the mirrors. As a variant, the optical motor may implement the LCoS (liquid crystal on silicon) technology, which relies on the use of a liquid crystal device, the light beam reflecting on the device. According to another variant, the optical motor may implement the GLV (grating light valve) technology, which relies on the use of a dynamically adjustable diffraction grating based on reflecting bands. According to another embodiment, projector P may implement at least one laser beam which is modulated according to the digital image, the image being obtained by an array scanning of the modulated laser beam.

Advantageously, when projector P is capable of projecting an image obtained from a digital image, the projected images may be simply obtained by modifying the digital image which controls projector P.

At step 32, second images are projected onto the object to be inspected, each second image comprising the same type of light patterns as the first images but with a second period T2 different from first period T1. Period T2 may be in the range from 1 mm to 15 mm. In the present embodiment of a method of determining a 3D image, at step 32, a plurality of second images with the patterns having the second period are successively projected onto circuit Board. The second images differ from one another by an offset of the patterns having the second period along a preferred direction. A 2D image is acquired during the projection of each new second image with light patterns onto circuit Board.

Generally, the larger period T, the greater the reconstruction depth, that is, the size of the height interval over which the 3D image may be determined by the method. Thereby, at least one of periods T1 or T2 is selected to have the desired reconstruction depth.

Step 32 may be repeated once or more than once with different periods.

At step 34, processing unit 16 determines a corrected 3D image of circuit Board.

According to an embodiment, processing unit 16 determines a first 3D image from the images acquired at step 30 and a second 3D image from the images acquired at step 32. Processing unit 16 then compares the first and second 3D images, for example, by determining, for each point of the 3D image, the difference between the height Z1 of the first 3D image and the height Z2 of the second 3D image. For the opaque portions of circuit Board, the difference between heights Z1 and Z2 is substantially null, for example, smaller the a given threshold. For the translucent portions of circuit Board, the difference between heights Z1 and Z2 is not null, for example, greater than a given threshold. Processing unit 16 thus determines the translucent portions of circuit Board. For each point of the translucent portions, processing unit 16 may determine the real height Z, for example, by extrapolation, from heights Z1 and Z2 and periods T1 and T2, considering that the relation between the height and the period is substantially linear.

Another embodiment of determination of a corrected 3D image will now be described. In this embodiment, the determination of the presence of translucent portions is carried out before the end of the method of determination of the first and second 3D images, which would normally be obtained with the first images and the second images, based on first intermediate data used for the determination of the first 3D image and on second intermediate data used for the determination of the second 3D image. As an example, the difference between the first intermediate data and the second intermediate data is determined. For the opaque portions of circuit Board, the difference between the first and second intermediate data is substantially null, for example, smaller than a given threshold. For the translucent portions of circuit Board, the difference between the first and second intermediate data is not null, for example, greater than a given threshold. Processing unit 16 thus determines the translucent portions of circuit Board. A determination of intermediate data corrected for the translucent portions is then performed and a 3D image corrected for the translucent portions is directly determined from the corrected intermediate data.

A more detailed embodiment will now be described for a specific example of a method of determining a 3D image.

Each point Qᵢ of the scene has a corresponding point ^{C}qᵢ in the image plane of camera C and a corresponding point ^{P}qᵢ in the image plane of projector P. A reference frame R_{C}(O_{C}, X′, Y′, Z′) associated with camera C is considered, where O_{C} is the optical center of camera C, direction Z′ is parallel to the optical axis of camera C, and directions X′ and Y′ are perpendicular to each other and perpendicular to direction Z′. In reference frame R_{C}, to simplify the following description, it can approximately be considered that point ^{C}qᵢ has coordinates (^{C}uᵢ, ^{C}vᵢ, f_{C}), where f_{C} is the focal distance of camera C. A reference frame R_{P}(O_{P}, X″, Y″, Z″) associated with projector P is considered, where O_{P} is the optical center of projector P, direction Z″ is parallel to the optical axis of projector P, and directions X″ and Y″ are perpendicular to each other and perpendicular to direction Z″. In reference frame R_{P}, to simplify the following description, it can be approximately considered that point ^{P}qᵢ has coordinates (^{P}uᵢ, ^{P}vᵢ, f_{P}), where f_{P} is the focal distance of projector P.

Generally, calling P_{P} the projection matrix of projector P and P_{C} the projection matrix of camera C, one has the following equation system (1) for each point Qᵢ, noted in homogeneous coordinates:

$$\{ \begin{matrix}{}_{}^{P}{q}{}_{i}^{} ( {z}_{i} ) ∼ {P}_{P} {Q}_{i} ( {z}_{i} ) \\ {}_{}^{C}{q}{}_{i}^{} ( {z}_{i} ) ∼ {P}_{C} {Q}_{i} ( {z}_{i} )\end{matrix} \qquad ( 1 )$$

Each point Qᵢ corresponds to the intersection of a line D_{C} associated with camera C and of a line D_{P} associated with projector P.

Each point ^{P}qᵢ of the image projected by projector P is associated a phase φᵢ(zᵢ). Light intensity I^{C}(^{C}qᵢ(zᵢ)), measured by the pixel at point ^{C}qᵢ of the image acquired by the camera and corresponding to point Qᵢ, follows relation (2) hereafter:

I^{C}(^{c}qᵢ(zᵢ))=A(zᵢ)+B(zᵢ)cos φᵢ(zᵢ) (2)

where A(hᵢ) is the light intensity of the background at point Qᵢ of the image, B(zᵢ) shows the amplitude between the minimum and maximum intensities at point Qᵢ of the projected image.

According to an example, projector P successively projects N different images onto the circuit, where N is a natural integer greater than 1, preferably greater than or equal to 4, for example, equal to 8.

A 2π/N phase-shift is applied for each new first or second image projected with respect to the previous first or second projected image. Light intensity I_{d}^{C}(^{C}qᵢ (zᵢ)), measured by the pixel at point ^{C}qᵢ for the d-th image acquired by the camera corresponding to point Qᵢ, follows relation (3) hereafter:

$${I}_{d}^{C} ( {}_{}^{C}{q}{}_{i}^{} ( {z}_{i} ) ) = A + B cos ( {φ}_{i} ( {z}_{i} ) + \frac{2 π}{N} d ) \qquad ( 3 )$$

where d is an integer which varies from 0 to N−1.

Vector [symbol] ᵢ^{C}(zᵢ) is defined according to relation (4) hereafter:

$${ℐ}_{i}^{C} ( {z}_{i} ) = ( \begin{matrix}{I}_{0}^{C} ( {}_{}^{C}{q}{}_{i}^{} ( {z}_{i} ) ) \\ ⋮ \\ {I}_{d}^{C} ( {}_{}^{C}{q}{}_{i}^{} ( {z}_{i} ) ) \\ ⋮ \\ {I}_{N - 1}^{C} ( {}_{}^{C}{q}{}_{i}^{} ( {z}_{i} ) )\end{matrix} ) = ( \begin{matrix}1 & 1 & 0 \\ ⋮ & ⋮ & ⋮ \\ 1 & cos ( \frac{2 π}{N} d ) & - sin ( \frac{2 π}{N} d ) \\ ⋮ & ⋮ & ⋮ \\ 1 & cos ( \frac{2 π}{N} ( N - 1 ) ) & - sin ( \frac{2 π}{N} ( N - 1 ) )\end{matrix} ) ( \begin{matrix}A \\ B cos {φ}_{i} ( {z}_{i} ) \\ B sin {φ}_{i} ( {z}_{i} )\end{matrix} ) \qquad ( 4 )$$

It is a linear equation system. It can be demonstrated that phase φᵢ(zᵢ) is given by relation (5) hereafter:

$${φ}_{i} ( {z}_{i} ) = arctan ( - \frac{{\sum }_{d = 0}^{N - 1} {I}_{d}^{C} sin ( \frac{2 π}{N} d )}{{\sum }_{d = 0}^{N - 1} {I}_{d}^{C} cos ( \frac{2 π}{N} d )} ) \qquad ( 5 )$$

According to the previously-described embodiment where intermediate data are used for the determination of the translucent portions, phase φᵢ(zᵢ) may correspond to the intermediate data used.

A literal expression of height zᵢ can generally be obtained.

An example of expression of height zᵢ will be described in a specific configuration where projector P and camera C are of telecentric type and where the following conditions are fulfilled:

the optical axes of projector P and of camera C are coplanar;
the projected images are of the type shown in FIG. 5, that is, they comprise straight fringes 25 which extend perpendicularly to direction (OX) and which have a sinusoidally-varying amplitude; and
lines D_{P} are perpendicular to plane Pl_{REF} and lines D_{C} form an angle θ with plane Pl_{REF}.

In this configuration, equation system (1) may then be simplified according to the following equation system (6):

$$\{ \begin{matrix}{x}_{i} = {}_{}^{P}{u}{}_{i}^{} \\ {z}_{i} = \frac{- 1}{tan θ} ( {x}_{i} - {x}_{iREF} )\end{matrix} \qquad ( 6 )$$

considering that point Q_{iREF} of coordinates (x_{iREF}, y_{iREF}, 0) is the point of reference plane Pl_{REF} associated with point of camera C.

In the image plane of projector P, abscissa ^{P}uᵢ of point ^{P}qᵢ follows, for example, relation (7) hereafter:

^{P}uᵢ=aφᵢ(zᵢ)+b (7)

where a and b are real numbers, a being equal to p₁/2π with p₁ corresponding to the pitch of sinusoidal fringes 25.

Based on relations (6) and (7), the following relation (8) is obtained:

$${z}_{i =} \frac{{p}_{i}}{2 π tan θ} ( {φ}_{i} ( {Q}_{iREF} ) - {φ}_{i} ( {Q}_{i} ) ) \qquad ( 8 )$$

where φ₁(Q_{iREF}) is equal to the phase at point Q_{iREF} of reference plane Pl_{REF}, that is, to the phase in the absence of circuit Board.

According to the previously-described embodiment where the 3D images are used for the determination of the translucent portions, height zᵢ may be used.

Specific embodiments have been described. Various alterations and modifications will occur to those skilled in the art. In particular, although an embodiment has been described where the determination of the 3D image is performed from an algorithm using the camera and the projector, it should be clear that the 3D image determination method may be implemented by a triangulation method using at least two cameras.

1. A method of determining a 3D image of an object, comprising:
the projection by at least one projector of a plurality of first images onto the object, each first projected image comprising first light patterns spaced apart by a first period;
the acquisition, for each first projected image, of at least one first two-dimensional image of the object by at least one image sensor;
the projection by said at least one projector of a plurality of second images onto the object, each second projected image comprising second light patterns spaced apart by a second period different from the first period;
the acquisition, for each second projected image, of at least one second two-dimensional image of the object by said at least one image sensor; and
the determination of a first height, or of first intermediate data from which the first height can be determined, for each point of the object based on the first two-dimensional images, the determination of a second height, or of second intermediate data from which the second height can be determined, for each point of the object based on the second two-dimensional images, the detection of at least one translucent area of the object by comparison of the first and second heights or of first and second intermediate data and, for each point of the translucent area, the determination of a third height for said point based on the first and second heights for said point and on the first and second periods or of third intermediate data from which the third height is determined for said point based on the first and second intermediate data for said point and on the first and second periods.

2. The method according to claim 1, further comprising:
the projection by said at least one projector of a plurality of third images onto the object, each third projected image comprising third light patterns spaced apart by a third period different from the first period and different from the second period;
the acquisition, for each third projected image, of at least one third two-dimensional image of the object by said at least one image sensor; and
the determination, for the translucent area, of the height of each point of the translucent area based on the first and second signals and on third signals obtained from the third images.

3. The method according to claim 1, wherein the first patterns are periodic along a given direction, with a period equal to the first period in the range from 1 mm to 15 mm.

4. The method according to claim 3, wherein the first light patterns comprise first light fringes.

5. The method according to claim 3, wherein the second patterns are periodic along the given direction, with a period equal to the second period in the range from 1 mm to 15 mm.

6. The method according to claim 5, wherein the second light patterns comprise second light fringes.

7. The method according to claim 6, wherein the first fringes are straight and parallel and wherein the second fringes are straight and parallel.

8. The method according to claim 1, wherein the first patterns are not periodic, the first period corresponding to the average interval between the first patterns.

9. The method according to any of claim 1, wherein the first light patterns are phase-shifted from a first projected image to the next one and wherein the second light patterns are phase-shifted from a second projected image to the next one.

10. A system for determining three-dimensional images of an object, comprising:
at least one projector configured to project a plurality of first images onto the object, each first projected image comprising first light patterns spaced apart by a first period, and a plurality of second images onto the object, each second projected image comprising second light patterns spaced apart by a second period different from the first period;
at least one image sensor configured to acquire, for each first projected image, at least one first two-dimensional image of the object and, for each second projected image, at least one second two-dimensional image of the object; and
a unit (16) configured to determine a first height, or first intermediate data from which the first height can be determined, for each point of the object based on the first two-dimensional images, to determine a second height, or second intermediate data from which the second height can be determined, for each point of the object based on the second two-dimensional images, to detect at least one translucent area of the object by comparison of the first and second heights or of the first and second intermediate data and, for each point of the translucent area, to determine a third height for said point based on the first and second heights for said point and on the first and second periods or third intermediate data from which the third height is determined for said point based on the first and second intermediate data for said point and on the first and second periods.

11. The system according to claim 10, comprising a unit for supplying digital images and wherein the projector is capable of projecting said plurality of images onto the object, each of said images being formed by the projector based on one of said digital images.
